(19) United States
(12) Patent Application Publication
(10) Pub. No.: US 2022/0032864 A1
(43) Pub. Date: Feb. 3, 2022

(54) GROMMET AND WIRE HARNESS

(71) Applicant: Yazaki Corporation, Tokyo (JP)

(72) Inventors: Hirotaka KIYOTA, Shizuoka (JP); Masaru KIUCHI, Shizuoka (JP); Takeshi ONODA, Shizuoka (JP)

(73) Assignee: Yazaki Corporation, Tokyo (JP)

(21) Appl. No.: 17/376,259

(22) Filed: Jul. 15, 2021

(30) Foreign Application Priority Data
Jul. 28, 2020 (JP) 2020-127273

(51) Int. Cl. B60R 16/02; H02G 3/04

(52) U.S. Cl. CPC B60R 16/0222; H02G 3/0406

(57) ABSTRACT

A grommet for a wire harness includes: a water sealing portion that is configured to be fitted into and water-seal a through hole; a first tubular portion that is provided on the inner side of the water sealing portion; a first annular wall portion that extends between the water sealing portion and the first tubular portion; a second annular wall portion that faces the first annular wall portion with a first space located between the first annular wall portion and the second annular wall portion, extends from the water sealing portion toward a central axis (C) side; and a first protrusion portion that is provided by protruding toward the first space S1 side from an inner wall surface of the first annular wall portion.

### CROSS-REFERENCE TO RELATED APPLICATION(S)

The present application claims priority to and incorporates by reference the entire contents of Japanese Patent Application No. 2020-127273 filed in Japan on Jul. 28, 2020.

### BACKGROUND OF THE INVENTION

### 1. Field of the Invention

The present invention relates to a grommet and a wire harness.

### 2. Description of the Related Art

Japanese Patent Application Laid-open No. 2017-085748 discloses a conventional grommet installed in a vehicle. The grommet includes a tubular section, which holds a cable inserted in the tubular section, and a bulging section, which bulges toward the tubular section and is connected to the outer circumference of the tubular section. The bulging section is formed by a plurality of protrusions arranged at intervals in the circumferential direction. With this grommet, when the cable held in the tubular section is moved in a direction that compresses the bulging section, adjacent protrusions come into contact with each other to limit the compression of the bulging section.

The grommet described in Japanese Patent Application Laid-open No. 2017-085748 may have protrusions formed in the hollow inner space of the grommet for various purposes. A configuration is desired that ensures suitable water sealing performance while maintaining productivity with such a structure.

### SUMMARY OF THE INVENTION

In view of the situation described above, it is an object of the present invention to provide a grommet and a wire harness capable of ensuring water sealing performance in a suitable manner.

In order to achieve the above mentioned object, a grommet according to one aspect of the present invention includes a water sealing portion that is formed in an annular shape around a central axis in an axial direction, the water sealing portion being configured to be fitted, in the axial direction, into a through hole formed in a mount target, and to water-seal the through hole; a first tubular portion that is provided on an inner side of the water sealing portion and formed in a tubular shape around the central axis, the first tubular portion being configured to receive a wiring material inserted into the first tubular portion in the axial direction; a first annular wall portion that is formed in an annular shape around the central axis and extends between the water sealing portion and the first tubular portion; a second annular wall portion that is formed in an annular shape around the central axis, faces the first annular wall portion in the axial direction with a first space located between the first annular wall portion and the second annular wall portion, extends from the water sealing portion toward the central axis side, and has a gap space between the first tubular portion and the second annular wall portion; and a first protrusion portion that is provided by protruding toward the first space side from an inner wall surface of the first annular wall portion on a side of the first space, the first protrusion portion being configured to come into contact with and be able to support an inner wall surface of the second annular wall portion on the side of the first space.

According to another aspect of the present invention, in the grommet, it is possible to further include a second tubular portion that is formed in a tubular shape around the central axis, and surrounds an outer side of the first tubular portion, an inside of the second tubular portion connecting to the gap space; and a second protrusion portion that is provided by protruding toward an opposite side of the first space side from an outer wall surface of the second annular wall portion on an opposite side of the inner wall surface, the second protrusion portion being configured to come into contact with and be able to support an outer surface of the second tubular portion.

According to still another aspect of the present invention, in the grommet, it is possible to further include a third annular wall portion that is formed in an annular shape around the central axis, faces the first annular wall portion in the axial direction with a second space located between the first annular wall portion and the third annular wall portion, the third annular wall portion being on an opposite side of the second annular wall portion side, and extends from the water sealing portion toward the central axis side, wherein the first annular wall portion is located between the second annular wall portion and the third annular wall portion in the axial direction.

In order to achieve the above mentioned object, a wire harness according to still another aspect of the present invention includes a conductive wiring material; and a grommet provided on the wiring material, wherein the grommet includes: a water sealing portion that is formed in an annular shape around a central axis in an axial direction, the water sealing portion being configured to be fitted, in the axial direction, into a through hole formed in a mount target, and to water-seal the through hole; a first tubular portion that is provided on an inner side of the water sealing portion and formed in a tubular shape around the central axis, the first tubular portion being configured to receive the wiring material inserted into the first tubular portion in the axial direction; a first annular wall portion that is formed in an annular shape around the central axis and extends between the water sealing portion and the first tubular portion; a second annular wall portion that is formed in an annular shape around the central axis, faces the first annular wall portion in the axial direction with a first space located between the first annular wall portion and the second annular wall portion, extends from the water sealing portion toward the first tubular portion side, and has a gap space between the first tubular portion and the second annular wall portion; and a first protrusion portion that is provided by protruding toward the first space side from an inner wall surface of the first annular wall portion on a side of the first space, the first protrusion portion being configured to come into contact with and be able to support an inner wall surface of the second annular wall portion on the side of the first space.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a grommet according to an embodiment;

FIG. 2 is a cross-sectional perspective view illustrating the schematic configuration of the grommet according to the embodiment;

FIG. 3 is a partial cross-sectional perspective view including a water sealing portion of the grommet according to the embodiment;

FIG. 4 is a partial cross-sectional perspective view including first protrusion portions of the grommet according to the embodiment; and

FIG. 5 is a schematic partial cross-sectional view illustrating an operation of the grommet according to the embodiment.

### DETAILED DESCRIPTION OF THE PREFERRED EMBODIMENTS

Referring to the drawings, an embodiment of the present invention is now described in detail. The present invention is not limited to this embodiment. The components of the following embodiment include those that can be replaced and easily contemplated by those skilled in the art or those that are substantially the same.

### EMBODIMENT

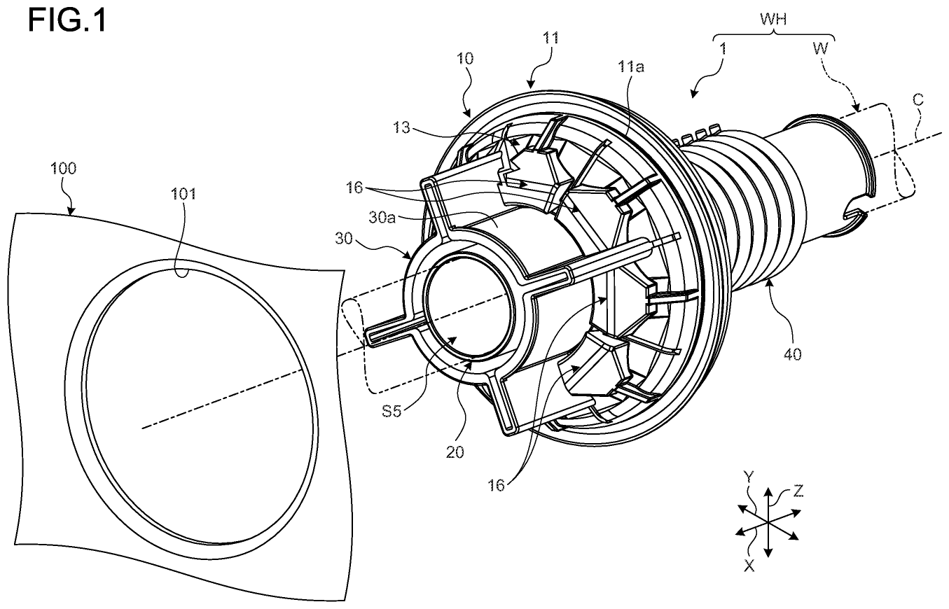

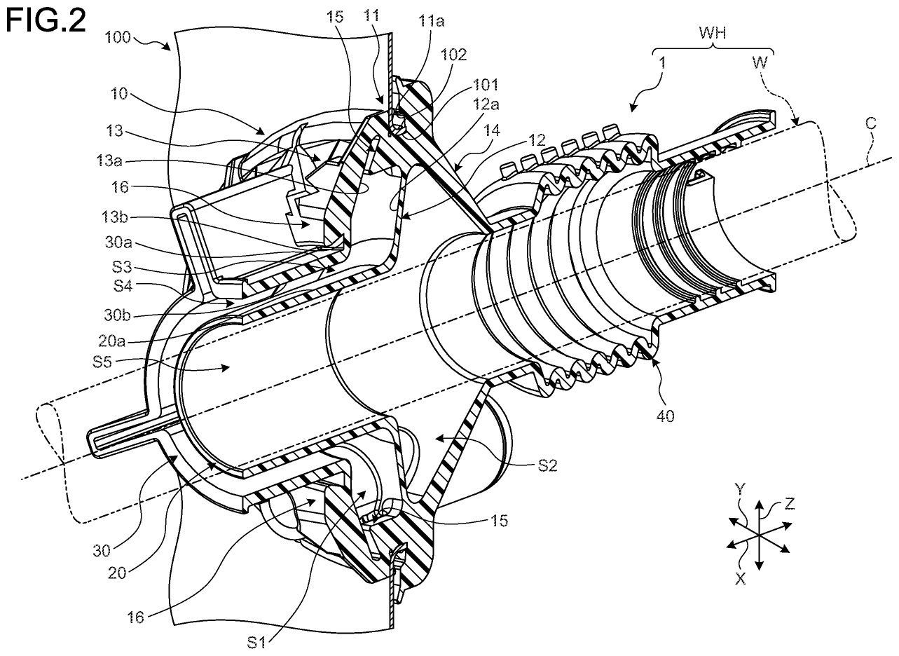

FIGS. 1 and 2 illustrate a grommet 1 of the present embodiment, which is to be incorporated in a wire harness WH routed in a vehicle or the like. For example, the wire harness WH may be an assembly of bundled wiring materials W used for power supply and signal communication to connect devices installed in the vehicle, and connects these wiring materials W to each device through connectors or other components. The wire harness WH includes conductive wiring materials W and the grommet 1, which is provided on the wiring materials W and through which the wiring materials W are inserted. The wire harness WH may further include various components such as exterior members including corrugated tubes, resin tapes, and protectors or the like, electric junction boxes, and fixtures. The wiring materials W are composed of, for example, a metal rod, an electric wire, an electric wire bundle, and the like. The metal rod is formed by covering the outer side of a conductive rod-shaped member with an insulating covering portion. The electric wire is formed by covering the outer side of a conductor portion (core wire) including a plurality of conductive metal strands with an insulating covering portion. The electric wire bundle is a bundle of electric wires. The wire harness WH bundles and combines a plurality of wiring materials W and is also electrically connected to various devices through connectors or other components provided at the ends of the bundled wiring materials W.

The grommet 1 is applied to a through hole 101 formed in a mount panel 100, which serves as a mount target, to route the wiring materials W through the through hole 101 and across two spaces partitioned by the mount panel 100. The mount panel 100 is a metal panel forming the body of a vehicle, for example. The through hole 101 extends through the mount panel 100 in a plate thickness direction. Burring is performed on the mount panel 100 around the through hole 101, so that the rim defining the through hole 101 projects toward one side in the plate thickness direction to form a projection 102. The two spaces partitioned by the mount panel 100 are typically a vehicle interior space (e.g., passenger compartment) and a vehicle exterior space (e.g., engine compartment). The grommet 1 is attached to the through hole 101 with the wiring materials W inserted into and enclosed by the grommet 1. The grommet 1 thus protects the wiring materials W passing through the through hole 101 and water-seals the through hole 101 (provides watertightness). In addition to the watertightness of the through hole 101, the grommet 1 provides functions such as dustproofing and sound insulating. The configuration of the grommet 1 is described in detail with reference to the drawings.

In the following description, of first to third directions intersecting one another, the first direction is referred to as an “axial direction X”, the second direction is referred to as a “width direction Y”, and the third direction is referred to as a “height direction Z”. The axial direction X, the width direction Y, and the height direction Z are typically perpendicular to one another. The axial direction X corresponds to the plate thickness direction of the mount panel 100 described above, and corresponds to the insertion direction of the wiring materials W and the grommet 1 relative to the through hole 101. In other words, the axial direction X is the direction in the extending direction of the wiring materials W inserted into the grommet 1. The width direction Y and the height direction Z correspond to extending directions of the mount panel 100. For the illustrative purpose, the wiring materials W are assumed to be routed linearly in the axial direction X in the following description. However, the configuration is not limited to this, and the axial direction X may be bent, and the grommet 1 and the wiring materials W may be partially bent in a state in which the grommet 1 is attached to the mount panel 100. Also, each direction used in the following description refers to the direction in a state in which the grommet 1 is attached to the mount panel 100 unless otherwise specified.

Specifically, as illustrated in FIGS. 1, 2, 3, and 4, the grommet 1 of the present embodiment serves as a sealing member in which the wiring materials W are inserted in the axial direction X and is capable of water-sealing the through hole 101 of the mount panel 100. The grommet 1 includes a main body portion 10, a first tubular portion 20, a second tubular portion 30, and a third tubular portion 40, which are integrally formed as an elastic body. These portions of the grommet 1 form a first space 31, a second space S2, a gap space S3, a communication space S4, and an insertion space S5. The grommet 1 may be made of an insulating elastic resin material having low rigidity and high flexibility, such as rubber or a thermoplastic elastomer (for example, ethylene-propylene-diene rubber (EPDM)).

The main body portion 10 is fitted into the through hole 101 in the axial direction X and water-seals the through hole 101. The wiring materials W are inserted into the main body portion 10 in the axial direction X. The main body portion 10 includes a water sealing portion 11, a first annular wall portion 12, a second annular wall portion 13, a third annular wall portion 14, first protrusion portions 15, and second protrusion portions 16.

The water sealing portion 11 is formed in a substantially annular shape around the central axis C in the axial direction X, is fitted into the through hole 101 in the axial direction X, and water-seals the through hole 101. The water sealing portion 11 is formed in a shape corresponding to the shape of the through hole 101. In this embodiment, the through hole 101 is formed in a substantially circular shape around the central axis C. Accordingly, the water sealing portion 11 is formed in a substantially annular shape around the central axis C as described above.

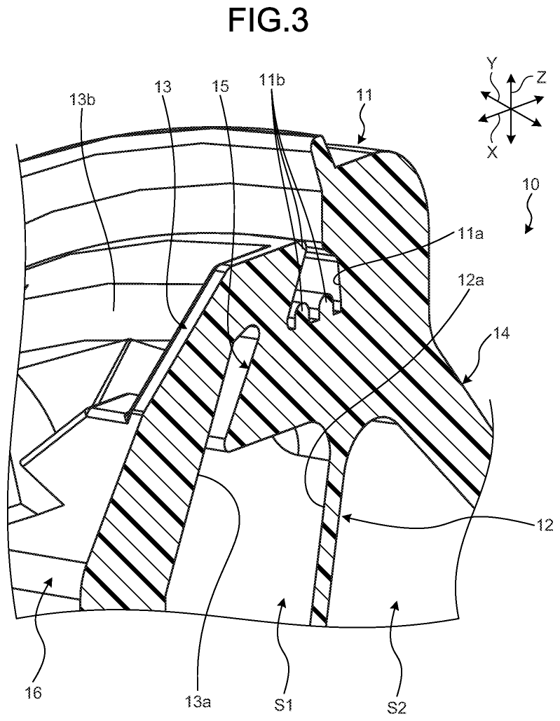

The water sealing portion 11 has a fitting groove 11a formed in the outer circumference surface along the circumferential direction (direction around the central axis C) (see FIG. 3). The fitting groove 11a is formed continuously in the circumferential direction in the outer circumference surface of the water sealing portion 11 as an annular groove around the central axis C. The water sealing portion 11 is formed such that, if divided along the fitting groove 11a in the axial direction X, one side (the side corresponding to the third annular wall portion 14, which will be described below) has a greater outer diameter than the other side (the side corresponding to the second annular wall portion 13, which will be described below).

The water sealing portion 11 has a lip portion 11b formed in the fitting groove 11a (see FIG. 3). The lip portion 11b is a fold-shaped portion formed along the fitting groove 11a. The lip portion 11b is formed in a substantially annular shape around the central axis C along the side surfaces and the bottom surface of the fitting groove 11a. The lip portion 11b contacts a surface of the rim (the projection 102) of the through hole 101 when the rim is fitted in the fitting groove 11a, and water-seals between the surface and the lip portion 11b. The lip portion 11b is configured to elastically deform to be in close contact with the surface of the rim (the projection 102) forming the through hole 101 and seal the entire circumference of the through hole 101.

The first annular wall portion 12, the second annular wall portion 13, and the third annular wall portion 14 are each formed in a substantially annular plate shape around the central axis C in the axial direction X. The first annular wall portion 12, the second annular wall portion 13, and the third annular wall portion 14 are located on the inner side of the water sealing portion 11 in a radial direction (a direction perpendicular to the central axis C) and close the spaces on the inner side of the water sealing portion 11. The first annular wall portion 12, the second annular wall portion 13, and the third annular wall portion 14 are opposed to and spaced apart from one another in the axial direction X, and their outer circumference edges are integrated at the water sealing portion 11. The outer circumference edges of the first annular wall portion 12, the second annular wall portion 13, and the third annular wall portion 14 are their edges located outside in the radial direction. That is, the water sealing portion 11 connects and integrates the outer circumference edges of the first annular wall portion 12, the second annular wall portion 13, and the third annular wall portion 14, which are located at the outer edges in the radial direction. In the main body portion 10, the second annular wall portion 13, the first annular wall portion 12, and the third annular wall portion 14 are arranged in this order from one side to the other in the axial direction X.

Specifically, the first annular wall portion 12 extends between the water sealing portion 11 and the first tubular portion 20, which will be described below, in the radial direction. The first annular wall portion 12 is connected to the water sealing portion 11 at its outer circumference edge and connected to the first tubular portion 20 at its inner circumference edge, thereby closing the gap between the water sealing portion 11 and the first tubular portion 20. The inner circumference edge of the first annular wall portion 12 is its edge located inside in the radial direction. The first annular wall portion 12, which configures a middle wall portion between the second annular wall portion 13 and the third annular wall portion 14 in the axial direction X, serves as a sound insulation wall portion for enhancing the sound insulation performance of the grommet 1.

The second annular wall portion 13 faces the first annular wall portion 12 in the axial direction X with the first space S1 located in between. The second annular wall portion 13 has the shape of a hollow dome that bulges toward one side in the axial direction X with respect to the first annular wall portion 12. The first space S1, which serves as a hollow portion, is formed between the first annular wall portion 12 and second annular wall portion 13. The second annular wall portion 13 extends from the water sealing portion 11 toward the central axis C side in the radial direction and also has the gap space S3 between the first tubular portion 20, which will be described below. The second annular wall portion 13 is connected to the water sealing portion 11 at its outer circumference edge and connected to the second tubular portion 30, which will be described below, at its inner circumference edge with the gap space S3 located between the inner circumference edge and the first tubular portion 20. The second annular wall portion 13 thus closes the gap between the water sealing portion 11 and the second tubular portion 30. The inner circumference edge of the second annular wall portion 13 is its edge located inside in the radial direction. The first space S1 functions as a sound insulation space for enhancing the sound insulation performance of the grommet 1. The gap space S3 functions as a mold removal opening for removing the mold in the manufacturing.

The third annular wall portion 14 is on the opposite side of the first annular wall portion 12 from the second annular wall portion 13 side and faces the first annular wall portion 12 in the axial direction X with the second space S2 located in between. The third annular wall portion 14 has the shape of a hollow dome that bulges in the direction opposite from the second annular wall portion 13 side in the axial direction X with respect to the first annular wall portion 12. The second space S2, which serves as a hollow portion, is formed between the first annular wall portion 12 and third annular wall portion 14. The third annular wall portion 14 extends from the water sealing portion 11 toward the central axis C side in the radial direction. The third annular wall portion 14 is connected to the water sealing portion 11 at its outer circumference edge and connected to the third tubular portion 40, which will be described below, at its inner circumference edge, thereby closing the gap between the water sealing portion 11 and the third tubular portion 40.

The inner circumference edge of the third annular wall portion 14 is its edge located inside in the radial direction. The second space S2 functions as a sound insulation space for enhancing the sound insulation performance of the grommet 1 together with the first space S1.

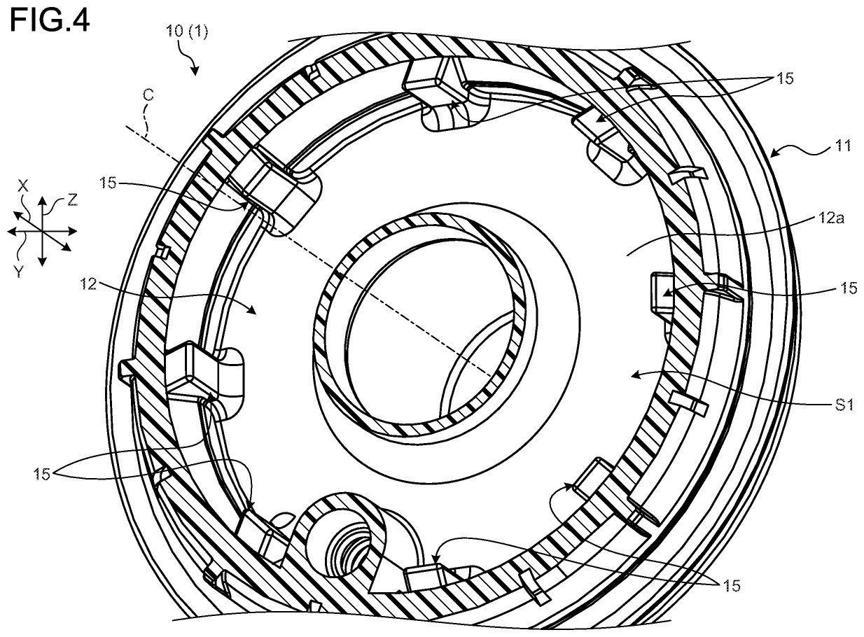

First protrusion portions 15 are provided by protruding toward the first space 31 side from an inner wall surface 12a of the first annular wall portion 12 on a side of the first space S1. The first protrusion portions 15 are formed to protrude inward toward the first space S1 from the inner wall surface 12a of the first annular wall portion 12. The first protrusion portions 15 are formed at an edge of the inner wall surface 12a of the first annular wall portion 12 on the water sealing portion 11 side in the radial direction, that is, at the outer circumference edge and at positions near the fitting groove 11a. The first protrusion portions 15 are provided at a plurality of positions in the circumferential direction around the central axis C and arranged radially (see FIG. 4). In this embodiment, the first protrusion portions 15 are located at eight positions at substantially equal intervals in the circumferential direction.

Each first protrusion portion 15 is formed to taper from the inner wall surface 12a of the first annular wall portion 12 toward the second annular wall portion 13 side in the axial direction X. Each first protrusion portion 15 is configured to come into contact with and be able to support an inner wall surface 13a of the second annular wall portion 13 on the side of the first space S1. When the main body portion 10 fitted in the through hole 101 deforms, each first protrusion portion 15 typically comes into contact with and supports the inner wall surface 13a of the second annular wall portion 13, thereby limiting the deformation of the main body portion 10.

Second protrusion portions 16 are provided by protruding toward the side opposite to the first space S1 side from an outer wall surface 13b of the second annular wall portion 13 on the opposite side the inner wall surface 13a. The second protrusion portions 16 are formed to protrude outward from the outer wall surface 13b of the second annular wall portion 13. The second protrusion portions 16 are formed from the middle portion to an edge of the outer wall surface 13b of the second annular wall portion 13 on the second tubular portion 30 side in the radial direction, that is, at the inner circumference edge and at positions near the second tubular portion 30. The second protrusion portions 16 are provided at a plurality of positions in the circumferential direction around the central axis C and extend radially. In this embodiment, the second protrusion portions 16 are located at eight positions at substantially equal intervals in the circumferential direction (four of which are illustrated in FIG. 1). In addition to the second protrusion portions 16, the outer wall surface 13b of the second annular wall portion 13 has various uneven structures, ribs, and the like.

Each second protrusion portion 16 is formed to protrude outward from the outer wall surface 13b of the second annular wall portion 13 in the axial direction X and taper toward an outer circumference surface 30a side of the second tubular portion 30 in the radial direction. Each second protrusion portion 16 is configured to come into contact with and be able to support the outer circumference surface 30a of the second tubular portion 30. When the main body portion 10 fitted in the through hole 101 deforms, each second protrusion portion 16 typically comes into contact with and supports the outer circumference surface 30a of the second tubular portion 30, thereby limiting the deformation of the main body portion 10.

The first tubular portion 20, the second tubular portion 30, and third tubular portion 40 are portions that are formed integrally with the main body portion 10 in tubular shapes and in which the wiring materials W are inserted in the axial direction X.

The first tubular portion 20 is provided on the inner side of the water sealing portion 11 in the radial direction. Specifically, the first tubular portion 20 is located on the inner side of the first annular wall portion 12 and second annular wall portion 13 in the radial direction. The first tubular portion 20 is formed in a substantially cylindrical shape around the central axis C and extends in the axial direction X. One end of the first tubular portion 20 in the axial direction X is open, while the other end is connected to the inner circumference edge of the first annular wall portion 12 as described above. In other words, the first tubular portion 20 is formed to protrude from the inner circumference edge of the first annular wall portion 12 toward one side along the axial direction X. The first tubular portion 20 also forms the gap space S3 between its outer circumference surface 20a and the inner circumference edge of the second annular wall portion 13 as described above.

The second tubular portion 30 is coaxial with the first tubular portion 20 and provided to surround the outer side of the first tubular portion 20 in the radial direction. Specifically, the second tubular portion 30 is located on the inner side of the second annular wall portion 13 in the radial direction. The second tubular portion 30 is formed in a substantially cylindrical shape around the central axis C and extends in the axial direction X. The second tubular portion 30 is formed in the substantially cylindrical shape having an inner diameter that is greater than the outer diameter of the first tubular portion 20. One end of the second tubular portion 30 in the axial direction X is open, while the other end is connected to the inner circumference edge of the second annular wall portion 13 as described above. In other words, the second tubular portion 30 is formed to protrude from the inner circumference edge of the second annular wall portion 13 toward one side along the axial direction X. The second tubular portion 30 surrounds the outer side of the first tubular portion 20 with a gap formed between the second tubular portion 30 and the outer circumference surface 20a of the first tubular portion 20. The inner space of the second tubular portion 30 connects to the gap space S3. Specifically, the second tubular portion 30, on its inner side, forms the communication space S4 between the inner circumference surface 30b of the second tubular portion 30 and the outer circumference surface 20a of the first tubular portion 20. The communication space S4 connects to the gap space S3. As described above, the second protrusion portions 16 of the second annular wall portion 13 can come into contact with the outer circumference surface 30a of the second tubular portion 30. The communication space S4 functions, together with the gap space S3, as the mold removal opening portion for removing the mold in the manufacturing. The outer circumference surface 30a of the second tubular portion 30 has various uneven structures, ribs, and the like.

The third tubular portion 40 is provided at a position opposed to the first tubular portion 20 in the axial direction X. Specifically, the third tubular portion 40 is located on the inner side of the third annular wall portion 14 in the radial direction. The third tubular portion 40 is formed in a substantially cylindrical shape around the central axis C and extends in the axial direction X. In this example, the third tubular portion 40 substantially has the shape of a cylinder with the same inner and outer diameters as the first tubular portion 20, and has a middle section with bellows. One end of the third tubular portion 40 in the axial direction X is open, while the other end is connected to the inner circumference edge of the third annular wall portion 14 as described above. In other words, the third tubular portion 40 is formed to protrude from the inner circumference edge of the third annular wall portion 14 toward one side along the axial direction X.

In the grommet 1 configured as described above, the inner spaces of the main body portion 10, the first tubular portion 20, and the third tubular portion 40 function as the insertion space S5. The insertion space S5, in which the wiring materials W are to be inserted, extends continuously across the inner space of the first tubular portion 20, the second space S2 of the main body portion 10, and the inner space of the third tubular portion 40 in the axial direction X. The grommet 1 receives the wiring materials W inserted in the axial direction X into the insertion space S5, which is formed continuously across the first tubular portion 20, the main body portion 10, and the third tubular portion 40.

After being attached to the wiring materials W by receiving the wiring materials W inserted into the insertion space S5, the grommet 1 is inserted into the through hole 101 from the side corresponding to the first tubular portion 20 and second tubular portion 30 together with the ends of the wiring materials W. The rim of the through hole 101 is fitted into the fitting groove 11a from the side corresponding to the second annular wall portion 13, which has a relatively small outer diameter, so that the water sealing portion 11 of the main body portion 10 is fitted into the through hole 101. The grommet 1 is thus attached to the mount panel 100. In this state, the lip portion 11b of the grommet 1 is in close contact with the surface of the rim of the through hole 101 while being elastically deformed, thereby sealing the entire circumference of the through hole 101. The openings of the second tubular portion 30 and third tubular portion 40 of the grommet 1 may be water-sealed by winding wrap tape or the like around the wiring materials W inserted into the insertion space S5 and the second tubular portion 30, and around the third tubular portion 40 and the wiring materials W.

Furthermore, when the main body portion 10 of the grommet 1 is fitted in the through hole 101, the first annular wall portion 12, which closes the gap between the water sealing portion 11 and the first tubular portion 20, functions as a sound insulation wall portion, and both of the first and second spaces 31 and S2, which form air layers, function as sound insulation spaces. This configuration allows the grommet 1 to attenuate the sound propagating through the through hole 101 with the first annular wall portion 12, the first space S1, the second space S2, and the like and insulate the sound, thereby improving the sound insulation performance.

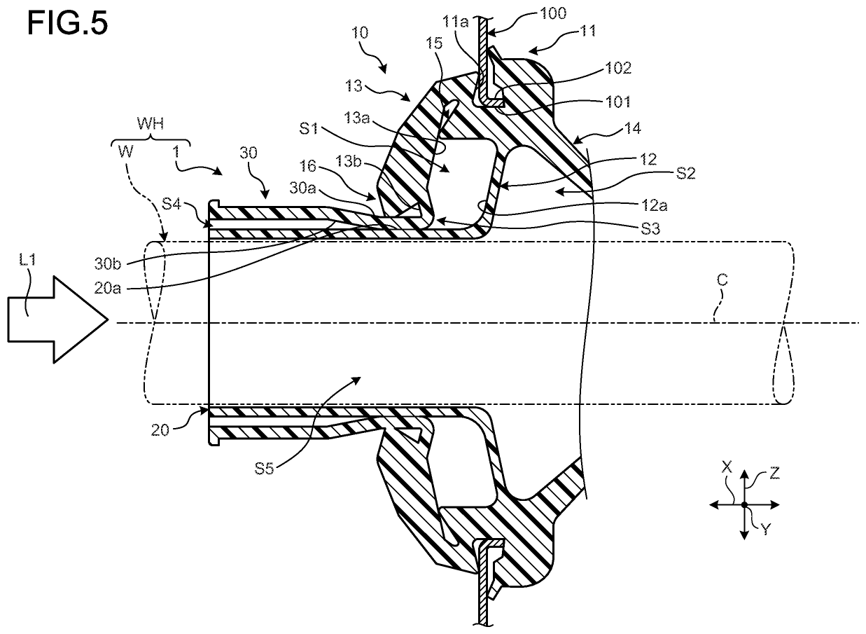

As illustrated in FIG. 5, when the wiring materials W are pulled toward the third annular wall portion 14 side, for example, a force L1 is applied to the grommet 1 in a direction that moves the main body portion 10 fitted in the through hole 101 away from the through hole 101 and toward the third annular wall portion 14 side. This force L1 elastically deforms the main body portion 10. In this case, the force L1 causes the main body portion 10 of the grommet 1 to be pressed against the mount panel 100 side and deformed such that the first annular wall portion 12 and the second annular wall portion 13 move closer to each other. Then, the first protrusion portions 15 come into contact with the inner wall surface 13a of the second annular wall portion 13 and support the inner wall surface 13a. The grommet 1 thus limits the deformation of the main body portion 10. As a result, the grommet 1 can maintain a state in which the water sealing portion 11 is fitted into and water-seals the through hole 101.

In this situation, the force L1 also affects the relation between the second annular wall portion 13 and the second tubular portion 30 and deforms the grommet 1 such that the second annular wall portion 13 and the second tubular portion 30 move closer to each other. The second protrusion portions 16 come into contact with the outer circumference surface 30a of the second tubular portion 30 and support the outer circumference surface 30a. The grommet 1 thus limits the deformation of the main body portion 10. This also allows the grommet 1 to maintain a state in which the water sealing portion 11 is fitted in and water-seals the through hole 101.

In the grommet 1 and the wire harness WH described above, the water sealing portion 11 is fitted into the through hole 101 formed in the mount panel 100 and water-seals the through hole 101, and the wiring materials W are inserted into the first tubular portion 20 and the like. The first annular wall portion 12, which functions as a sound insulation wall portion, and the first space S1 and the like, which function as sound insulation spaces, allow the grommet 1 to attenuate the sound propagating through the through hole 101, limit the transmission of the sound, and insulate the sound, thereby improving the sound insulation performance.

In this configuration, the grommet 1 is provided with the first protrusion portions 15 in the first space S1 formed between the first annular wall portion 12 and second annular wall portion 13, which extend from the water sealing portion 11. The first protrusion portions 15 can support the inner wall surface 13a of the second annular wall portion 13. With this configuration, when an external force deforms the water sealing portion 11 fitted in the through hole 101, the first protrusion portions 15 come into contact with the inner wall surface 13a of the second annular wall portion 13 and support the inner wall surface 13a. The grommet 1 thus limits the deformation of the second annular wall portion 13 and the water sealing portion 11. As a result, the grommet 1 has a suitable retention force that maintains a state in which the water sealing portion 11 is fitted in and water-seals the through hole 101, while limiting an increase in the insertion force required to insert and fit the water sealing portion 11 into the through hole 101.

The first protrusion portions 15 for ensuring the retention force are provided in the first space S1 so as to protrude toward the first space S1 side from the inner wall surface 12a of the first annular wall portion 12 side, which faces the gap space S3 formed at the second annular wall portion 13 side. This configuration facilitates the formation of the inner shape of the grommet 1 forming the first space S1. As such, the grommet 1 can have a shape that reduces the likelihood that the mold is caught by the first protrusion portions 15 when the mold is removed in the manufacturing, and allows the mold to be removed easily toward the gap space S3 side. The inner wall surface 13a of the second annular wall portion 13 located on the gap space S3 side is formed as a smooth surface that is more even than the inner wall surface 12a of the first annular wall portion 12 including the first protrusion portions 15. The grommet 1 thus preferably reduces the likelihood that the mold is caught by the inner wall surface 13a side of the second annular wall portion 13 as described above. As a result, the grommet 1 can shorten the working time required to remove the mold and improve the productivity.

As described above, the grommet 1 and the wire harness WH of the present embodiment have a structure capable of improving the productivity while ensuring a low insertion force, a suitable retention force, and sound insulation performance, thereby ensuring the water sealing performance in a suitable manner. In other words, the grommet 1 and the wire harness WH can improve the productivity while having suitable assembly workability, retention performance, sound insulation performance, and water sealing performance.

Moreover, the grommet 1 and the wire harness WH described above support the outer circumference surface 30a of the second tubular portion 30 with the second protrusion portions 16 provided on the outer wall surface 13b of the second annular wall portion 13. With this configuration, when an external force deforms the water sealing portion 11 fitted in the through hole 101, the second protrusion portions 16 come into contact with the outer circumference surface 30a of the second tubular portion 30 and support the outer circumference surface 30a. The grommet 1 thus limits the deformation of the second annular wall portion 13 and the water sealing portion 11. The first protrusion portions 15 limits the deformation of the outer circumference side of the second annular wall portion 13, while the second protrusion portions 16 limit the deformation of the inner circumference side of the second annular wall portion 13. This allows the grommet 1 to preferably limit the overall deformation. As such, the grommet 1 can obtain the retention force for maintaining a state in which the water sealing portion 11 is fitted in and water-seals the through hole 101 in a more preferable manner. Furthermore, in the grommet 1 and the wire harness WH, the gap space S3 connects to the communication space S4 inside the second tubular portion 30, with which the second protrusion portions 16 come into contact. This allows the mold to be removed through the gap space S3 and the communication space S4 in a suitable manner.

In addition to the first space S1, the grommet 1 and the wire harness WH described above have the second space S2 formed between the first annular wall portion 12 and the third annular wall portion 14. The first annular wall portion 12 functions as a sound insulation wall portion that separates the first space S1 from the second space S2. This configuration allows the grommet 1 and the wire harness WH to further improve its sound insulation performance and also ensure the water sealing performance in a suitable manner as described above.

The grommet and the wire harness according to the embodiment of the present invention described above are not limited to the embodiment described above, and various modifications can be made within the scope of the claims.

In the above description, the main body portion 10 includes the third annular wall portion 14 and the second protrusion portions 16, but the present invention is not limited to this. The main body portion 10 may be a configuration that does not include the third annular wall portion 14 or the second protrusion portions 16.

In the above description, the through hole 101 is formed in a substantially circular shape around the central axis C, and the water sealing portion 11 is formed accordingly in a substantially annular shape around the central axis C. However, the present invention is not limited to this. For example, the through hole 101 may be formed in an elliptical shape, and the water sealing portion 11 may be formed in an elliptical shape accordingly.

The grommet and the wire harness according to the present embodiment may be configured by appropriately combining components of embodiments and modifications described above.

In a grommet and a wire harness according to the present embodiment, a water sealing portion is fitted into a through hole formed in a mount target and water-seals the through hole, and a wiring material is inserted into the first tubular portion. In this configuration, the grommet is provided with first protrusion portions in a first space formed between first and second annular wall portions, which extend from the water sealing portion. The first protrusion portions can support an inner wall surface of the second annular wall portion. This configuration allows the grommet to obtain the retention force for maintaining a state in which the water sealing portion is fitted in and water-seals the through hole in a suitable manner. The first protrusion portions are provided in the first space so as to protrude toward the first space side from the inner wall surface of the first annular wall portion, which faces the gap space formed at the second annular wall portion side. This configuration facilitates the formation of the inner shape of the grommet forming the first space. As a result, the grommet and the wire harness have an advantageous effect of ensuring the water sealing performance in a suitable manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a water sealing portion that is formed in an annular shape around a central axis in an axial direction, the water sealing portion being configured to be fitted, in the axial direction, into a through hole formed in a mount target, and to water-seal the through hole;
a first tubular portion that is provided on an inner side of the water sealing portion and formed in a tubular shape around the central axis, the first tubular portion being configured to receive a wiring material inserted into the first tubular portion in the axial direction;
a first annular wall portion that is formed in an annular shape around the central axis and extends between the water sealing portion and the first tubular portion;
a second annular wall portion that is formed in an annular shape around the central axis, faces the first annular wall portion in the axial direction with a first space located between the first annular wall portion and the second annular wall portion, extends from the water sealing portion toward the central axis side, and has a gap space between the first tubular portion and the second annular wall portion; and
a first protrusion portion that is provided by protruding toward the first space side from an inner wall surface of the first annular wall portion on a side of the first space, the first protrusion portion being configured to come into contact with and be able to support an inner wall surface of the second annular wall portion on the side of the first space.

2. The grommet according to claim 1, further comprising:
a second tubular portion that is formed in a tubular shape around the central axis, and surrounds an outer side of the first tubular portion, an inside of the second tubular portion connecting to the gap space; and
a second protrusion portion that is provided by protruding toward an opposite side of the first space side from an outer wall surface of the second annular wall portion on an opposite side of the inner wall surface, the second protrusion portion being configured to come into contact with and be able to support an outer surface of the second tubular portion.

3. The grommet according to claim 1, further comprising:
a third annular wall portion that is formed in an annular shape around the central axis, faces the first annular wall portion in the axial direction with a second space located between the first annular wall portion and the third annular wall portion, the third annular wall portion being on an opposite side of the second annular wall portion side, and extends from the water sealing portion toward the central axis side, wherein
the first annular wall portion is located between the second annular wall portion and the third annular wall portion in the axial direction.

4. The grommet according to claim 2, further comprising:
a third annular wall portion that is formed in an annular shape around the central axis, faces the first annular wall portion in the axial direction with a second space located between the first annular wall portion and the third annular wall portion, the third annular wall portion being on an opposite side of the second annular wall portion side, and extends from the water sealing portion toward the central axis side, wherein
the first annular wall portion is located between the second annular wall portion and the third annular wall portion in the axial direction.

5. A wire harness comprising:
a conductive wiring material; and
a grommet provided on the wiring material, wherein
the grommet includes:
a water sealing portion that is formed in an annular shape around a central axis in an axial direction, the water sealing portion being configured to be fitted, in the axial direction, into a through hole formed in a mount target, and to water-seal the through hole;
a first tubular portion that is provided on an inner side of the water sealing portion and formed in a tubular shape around the central axis, the first tubular portion being configured to receive the wiring material inserted into the first tubular portion in the axial direction;
a first annular wall portion that is formed in an annular shape around the central axis and extends between the water sealing portion and the first tubular portion;
a second annular wall portion that is formed in an annular shape around the central axis, faces the first annular wall portion in the axial direction with a first space located between the first annular wall portion and the second annular wall portion, extends from the water sealing portion toward the first tubular portion side, and has a gap space between the first tubular portion and the second annular wall portion; and
a first protrusion portion that is provided by protruding toward the first space side from an inner wall surface of the first annular wall portion on a side of the first space, the first protrusion portion being configured to come into contact with and be able to support an inner wall surface of the second annular wall portion on the side of the first space.
